(19) United States
(12) Patent Application Publication
(10) Pub. No.: US 2013/0304602 A1
(43) Pub. Date: Nov. 14, 2013

(54) Marketing Methods

(71) Applicant: Frank J. Uxa, Jr., Mission Viejo, CA (US)

(72) Inventor: Frank J. Uxa, Jr., Mission Viejo, CA (US)

(21) Appl. No.: 13/835,882

(22) Filed: Mar. 15, 2013

Related U.S. Application Data
(60) Provisional application No. 61/642,672, filed on May 4, 2012.

(51) Int. Cl. G06Q 30/06

(52) U.S. Cl. CPC G06Q 30/0611
USPC 705/26.4

(57) ABSTRACT

A method of marketing automobiles (other high priced products) to a plurality of parties (individuals) includes using a micro-chip-based computing device (computer), for example, at least one computer and at least one internet website associated with the at least one computer, to obtain information from a plurality of parties regarding the identity of one or more automobiles each party wants and is willing to purchase; and processing the information to identify a particular automobile which is willing to be purchased by at least a minimum number of the parties from whom the information is obtained.

The present invention relates to methods of marketing goods. In order to straightforwardly present or disclose various aspects and examples of the invention, such presentation or disclosure is made herein focusing on marketing automobiles. However, it is to be understood that the present invention may be applied and be effective in marketing other goods, for example, as noted elsewhere herein.

An individual seeking to purchase an automobile may visit several different automobile dealers to consider new automobiles and inquire about the price of the automobiles. Such automobile purchasing may have a significant, and possibly stressful, amount of visiting and negotiating with different dealers, considering different automobiles, weighing different factors, for example, optional features or options to be included on the automobile(s), prices and the like before negotiating the individual purchase of an automobile from a dealer at an agreed to purchase price, which purchase may involve the purchaser obtaining a loan for at least a portion of the purchase price of the automobile.

Because the individual purchaser is often interested in purchasing only a single automobile, among other reasons, he/she has little leverage with the dealer in negotiating the purchase price of the automobile. As a result the individual pays a relatively high purchase price for an automobile. In addition, the purchase price paid by an individual purchasing an automobile from an automobile dealer, as noted above, includes charges (often hidden from the purchaser) for, for example, dealer overhead, commissions to salespeople and other expenses incurred by the dealership to support dealing with separate individual automobile purchasers.

It would be advantageous to be able to more easily and/or less stressfully and/or less expensively purchase an automobile, for example, relative to the approach outlined above.

### SUMMARY OF THE INVENTION

The present invention is directed to methods of marketing, and, in one example, providing, transportation vehicles, such as automobiles, to a plurality of individuals. The present methods may allow individuals to purchase automobiles while spending less time and/or enduring less stress and/or spending less money relative to a method, for example, as outlined above, in which an individual visits one or more dealers, selects an automobile and negotiates directly with the dealer for the purchase of that automobile. The present methods may result in lower dealer cost per vehicle sold.

In one aspect, the present invention is a method of marketing automobiles to a plurality of individuals. The method comprises using a micro-chip-based computer device (computer) or other micro-chip-based computational device, such as a smart phone, and the like. For example, at least one Internet website can be used in methods of marketing automobiles to a plurality of individuals, which methods comprise obtaining and processing automobile preference information from parties, such as individuals, that is a plurality of parties or individuals to identify one or more automobiles that a plurality of individuals want and are willing to purchase.

In one example, the present methods further comprise contacting the plurality of parties each of whom wants and is willing to purchase an automobile, for example, a particular automobile, to obtain verification that such parties are interested in purchasing and that such parties are qualified to purchase the automobiles. Such contacting any include one or more of confirming the financial credit worthiness of each of such parties or individuals; transmitting loan/purchase documents to such credit worthy parties or individuals, e.g., for consideration and execution; and the like.

In one example, the present methods further comprise contacting at least one automobile supplier, such as an automobile manufacturer or an automobile dealer, to negotiate a sales price for the number of automobiles to be sold to the qualified parties. The negotiated sales or purchase price of each automobile resulting from this negotiation of the purchase price for a number of automobiles may be less than the sales or purchase price of a single automobile, which is substantially identical to the automobiles, sold to a single individual purchaser.

In one example, particular automobiles, for example, a number or plurality of particular automobiles to be purchased, may include automobiles that are substantially identically the same and/or automobiles that are sufficiently similar so that an automobile supplier is willing to discount the purchase price of such sufficiently similar automobiles to substantially the same extent as if the automobiles were identically the same.

In one example, the present methods further comprise consummating the purchase transactions, for example, for each of the qualified parties, including, for example, obtaining execution of all required automobile purchase-related documents, delivering the automobiles to the purchasers and the like events which conventionally or routinely occur in consummating the purchase transaction.

In one example, one or two or more than two individual Internet websites may be used in practicing the present methods. These websites may include one or more non-secure or non-secured websites and/or one or more secure or secured websites. For example, the initial contact of parties to obtain purchase preference information may be accomplished using a non-secure or a secure website. In addition, one or more non-secure or secure websites may be used to provide detailed information, or how to obtain detailed information, on automobiles, for example, a number of different automobiles from the same automobile manufacturer or different automobile manufacturers, that may be of interest to individuals visiting the website.

Further contact with the parties, for example, to confirm purchase interest, to obtain credit information, to provide purchase price information, to provide purchase documents and the like, may be accomplished using one or more secure websites, for example, to protect privacy and maintain confidentiality.

The website or websites employed or utilized in performing the present methods may be owned and/or operated by a single entity or by a plurality of related and/or unrelated entities. In one example, one or more of the websites may be owned and/or may be operated by a first entity or a first plurality of related entities, while one or more other websites may be owned and/or operated by a different second entity or a different second plurality of entities which may be related or not related to the first entity or first plurality of entities.

For example, the website or websites involved in the solicitation/inquiry steps may be owned and/or operated by an entity not directly related to an automobile supplier; and the website or websites involved in other steps, for example, involving confirmation of credit worthiness, providing detailed purchase price information and other terms, and finalization and consummation of the purchase may be owned/operated by a vehicle supplier and/or other entity or other entities, for example, one or more related entities and/or non-related entities.

In addition, in one example, one or more steps of the present methods, for example, the other steps, as noted above, may involve means of communication, for example, person-to-person contact, telephone contact and the like, other than internet websites. Methods which include step or steps involving such non-computer or non-internet website communication are within the scope of the present invention. Methods in which such step or steps and/or other steps are conducted using one or more websites are included within the scope of the present invention.

Because a relatively large number of automobiles may be purchased at one time, for example, under one master order or two or more related master or large offers, the purchase price, e.g., the negotiated purchase price, for each automobile purchased in accordance with the present methods may be significantly lower than the purchase price of one substantially identical automobile sold to one party or individual. In one example, the larger the number of automobiles purchased, the lower the per automobile purchase price may be.

In addition, because one or more steps of the present methods may involve using a computer, for example, from the home of a prospective purchaser, the prospective purchaser spends less time and is less stressed than if he/she was to visit and negotiate directly with one automobile dealer (supplier) or a number of automobile dealers (suppliers), for example, as outlined above.

Further, the relatively large number of automobiles per order and the reduced purchase price per automobile which may be purchased in accordance with the present methods may allow the owner(s)/operator(s) of the website(s) and/or other facilities involved in practicing or facilitating the practice of the present methods to recover a fee (from the purchasers and/or the vehicle suppliers, e.g., automobile manufacturers, dealers and the like) without destroying the financial advantage of the transaction to the purchasers and/or the vehicle suppliers.

The terms “computer website”, “website” or “internet website” mean a website on the Internet which can be accessed by a computer, for example, a micro-chip-based computer, such as a general purpose computer, lap-top computer, tablet computer or other micro-chip-based computer or computational device, for example and without limitation, telephone, smart phone and the like. The term “computer” includes any device, which can access one or more of the websites contemplated herein, and may include one or more devices which are not classically or conventionally referred to as a computer.

The presently disclosed methods may be applied to marketing any goods or class of goods. For example, the present methods may be applied to low priced, moderately priced and high priced goods. For example, high priced goods, such as automobiles, trucks, other transportation vehicles, other vehicles, other goods which often require the purchaser to obtain a loan for at least a portion of the purchase price, and the like may be marketed using the present methods. Also, goods which are sold by at least two or more competitors for example, competing manufacturers, competing dealers, competing distributors and the like; goods which can be customized by the selection of one or more options; and the like may be marketed using the present methods.

Various examples of the present invention are described in detail in the detailed description and additional disclosure below. Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any example of the present invention.

### DETAILED DESCRIPTION

The present methods provide for marketing automobiles to individuals (parties) and for allowing individuals (parties) to purchase their preferred automobiles more conveniently and/or at reduced purchase prices. The per automobile cost to the automobile supplier of supplying the automobile in accordance with the present methods may be reduced relative to the automobile supplier negotiating and selling the same identical automobiles separately to the parties individually.

One illustrative example of a method of the present invention is generally as set forth below, it being understood that the invention is not limited to such example.

A computer internet website is set up where individuals are asked to identify one or more automobiles which they would be willing to purchase (including make and model of automobile, as well as added equipment or options, color, etc. in as much/or as little detail as desired or as would make a difference, for example, would affect the decision to purchase or not, to the prospective purchaser.

Based on the individual responses, and, for example, using conventional or well known data processing techniques, for example, using a micro-chip-based computer system, automobiles are identified which have been selected by at least a minimum, for example, a pre-selected minimum, number of individuals (parties), for example, at least about 10, at least about 50, at least about 100 or more.

These individuals (parties) who have selected one or more of such automobiles may be contacted, for example, using a computer Internet website, and asked to (1) confirm their interest in purchasing the selected automobile, and (2) authorize the obtaining of their credit scores to qualify as being creditworthy to purchase the selected automobile. Such individuals (parties) may also be asked to identify a purchase price or purchase price range at which they would have interest in purchasing the selected automobile.

In one example, the information obtained from contacting the individuals (parties) who have selected one or more of such automobiles is reviewed or analyzed to determine whether or not a sufficient number of creditworthy individuals remain interested in purchasing the selected automobile at a price or in a price range that is reasonably obtainable from an automobile supplier. As a result of this information review or analysis, further contact with the individuals (parties) who have selected such automobile may occur, for example, using a computer Internet website, to inquire and/or confirm if such individuals would be willing to purchase a selected automobile at a purchase price within a reasonable price range, for example, within a specific reasonable price range. Such further contact may advise such individuals (parties) that no further action will be taken, for example, since there are not a sufficient number of individuals (parties) who are now interested (and creditworthy) in purchasing such automobile.

An automobile supplier, e.g., automobile manufacturer, automobile dealer and the like, may be contacted and a negotiated purchase price (fleet price or less) for the selected automobiles is reached. This price may include a service charge for the website(s), for example, one the order of about 1% or less, or about 3% to about 5% or more than 5% of the purchase price of the selected automobile.

The transaction may proceed as follows. The negotiated price is agreed to by the qualified individuals (parties); the individuals (parties) obtain their loans, for example, from the automobile supplier, a bank, the website or other source; the website and vehicle supplier are paid; and each of the automobiles is delivered to each of the purchasers.

### ILLUSTRATIVE EXAMPLE OF METHOD

### 1. Initial Dealings

A. An internet website including listings of automobiles available including color, equipment and other options available on each automobile may be set up. This website may include detailed information on a number of automobiles and/or may provide one or more links to other website(s) where such detailed information can be obtained.

B. In one example, the website in A can be promoted. For example, using one or more advertising media, for example and without limitation, one or more internet websites, cable media outlets, broadcast media outlets, newspapers, other print media, direct solicitation (including telephone) and the like and combinations thereof, individual (party) potential automobile purchasers can be invited to visit the internet website identified in A.

C. Individuals (parties) visiting the website identified in A may be asked to identify one or more automobiles he/she is willing to purchase (including color, equipment and other options in as much/or as little detail as desired or as would make a difference (would affect the decision to purchase or not) to the individual (party)). The individual (party) may be asked to identify a specific price or price range that the individual (party) would be willing to purchase each of the one or more identified automobiles.

D. The individuals (parties) who respond in C may be asked for sufficient information, for example, an E-mail address, telephone number, street address, etc., so that they can be contacted further.

### 2. Processing Initial Information

Using conventional (well known) data processing techniques, for example, a suitably programmed micro-chip based computer system or similar system or device, one or more of the following steps can be taken:

A. Compile information received from the individuals (parties) in INITIAL DEALINGS, as noted above.

B. Identify one or more automobiles (particular or selected automobiles) which have been selected by at least a required minimum number, for example, by at least 2 or 3 or at least about 5, or at least about 10, or at least about 50, or at least about 100 or more, of the individuals (parties). Call these particular or selected automobiles: A Vehicles or Class A Vehicles.

C. Identify one or more other automobiles which have been selected by at least a fraction, for example, a set fraction, of the required minimum number of the individuals (parties). Call these other automobiles: B Vehicles or Class B Vehicles.

D. Identify one or more further automobiles which have been selected by less than a set fraction of the required minimum number of individuals (parties). Call these further automobiles: C Vehicles or Class C Vehicles.

### 3. Additional Dealings With Purchases

Using an Internet website (which may be the same website or a different website as in 1 above), one or more of the following steps may be taken:

A. Contact individuals (parties) who previously expressed an interest in purchasing a particular A Vehicle (A Vehicle Prospective Purchaser or AVPP) to confirm their continued interest in purchasing the particular A Vehicle. Also, may confirm that the AVPPs are willing to purchase the particular A Vehicle at a reasonable price or at a price within a reasonable price range.

B. If continued interest and willingness to purchase exists, obtain authority from each such AVPP to obtain credit scores to confirm credit worthiness.

C. Obtain credit scores of such AVPPs to identify credit approved AVPPs (referred to herein as CAVPPs).

D. Confirm with each CAVPP that he/she have been credit approved.

E. Forward to each CAVPP a Letter of Intent (LOI) or similar document confirming such CAVPP's intent to purchase the particular A Vehicle at a reasonable price or within a reasonable price range, and ask each CAVPP to execute the LOI and to return the executed LOI by mail or electronically to the website.

F. The individuals (parties) who selected B Vehicles and C Vehicles may be contacted to inform them that they have selected a B Vehicle or a C Vehicle, as the case may be, and to inquire if they would be interested in purchasing an A Vehicle and/or a B Vehicle. If there is interest in purchasing an A Vehicle, the individual in question is considered an AVPP and may be asked to participate as an AVPP, as noted above. If there is interest in purchasing a B Vehicle, the individual in question may be added to the other individuals interested in purchasing the same B Vehicle. The addition of this individual may convert this B Vehicle to an A Vehicle.

### 4. Dealing With the Automobile Supplier

A. An automobile supplier (e.g., an automobile manufacturer, dealer, etc.) may be contacted. More than one automobile supplier may be contacted. This can occur before or after an automobile (or a closely related family of automobiles) has been identified as an A Vehicle. Purchase price and delivery terms may be negotiated between the owner/operator of the website(s) and the chosen automobile supplier. Favorable (low cost) terms may be expected (even demanded) because of the relatively large number of automobiles being ordered.

B. The price per automobile may be increased by a website portion (WSP) to compensate the website for its efforts. The price quoted to each CAVPP may be the price agreed to with the automobile supplier plus the WSP.

C. The price per automobile may be communicated to each CAVPP of such automobile as early as possible in order to assure the CAVPP is informed and remains committed to purchase the automobile.

### 5. Finalizing the Transaction

A. Using a micro-chip-based computer system, the purchase documents (for example, one or more loan/credit documents, warranty election documents, etc.) may be provided to each CAVPP for review and execution.

B. The executed purchase documents and a down payment from each CAVPP may be provided to the automobile supplier. The WSP may be provided to the owner/operator of the service/website(s).

C. Arrangements may be made with each CAVPP and the automobile supplier for delivery of the automobile to each CAVPP.

The above-described Outline of Transaction sets forth a number of steps that may be included in practicing the present methods. Any transaction in accordance with the present methods may not include some or all of the steps set forth herein and/or may include one or more additional steps.

Each and every United States Patent each and every United States Patent Publication referred to herein is hereby specifically and individually incorporated in its entirety herein by reference. Included, without limitation, are U.S. Pat. Nos. 7,970,687; 8,027,911; and 8,055,565.

While this invention has been described with respect to various specific examples and embodiments, it is to be understood that the invention is not limited thereto and that it can be variously practiced within the scope of the following claims.

1. A method of Marketing automobiles to a. plurality of parties, the method comprising:
using a micro-chip-based computing device and at least one internet website associated with the computing device to obtain information from a plurality of parties regarding the identity of one or more automobiles each party wants and is willing to purchase; and
processing the information to identify a particular automobile which is willing to be purchased by at least a minimum number of the parties from whom information is obtained.

2. The method of claim 1, which further comprises contacting the parties who are willing to Purchase the particular automobile to obtain verification that such parties are interested in purchasing, and that such parties are qualified to purchase, the particular automobile.

3. The method of claim 1 which further comprises contacting at least one automobile supplier to negotiate a purchase price for the number of particular automobiles to be sold to the qualified parties.

4. The method of claim 3, which further comprises consummating the purchase of the particular automobiles from the automobile supplier by the qualified parties.

5. The method of claim 1, which further comprises soliciting a population of parties to provide information regarding the identity of one or more automobiles each party wants and is willing to purchase.

6. The method of claim 5, wherein the soliciting comprises using one or more of internet websites, cable media, broadcast media, newspapers, other print media, direct solicitation and combinations thereof.

7. The method of claim 1, wherein the processing step comprises using a computer to compile and analyze the information to determine which automobiles identified by the plurality of parties are Class A vehicles, Class B vehicles and Class C vehicles, wherein Class A vehicles are automobiles that have been identified by at least the required minimum number of the parties; Class B vehicles are automobiles that have been identified by at least a set fraction of the required minimum number of the parties; and Class C vehicles are automobiles that have been identified by less than the set fraction of the required minimum number of the parties.

8. The method of claim 7, wherein the particular automobile is a Class A vehicle.

9. The method of claim 7, which further comprises inquiring of one or more other parties to determine whether the other party or parties wants and is willing to purchase one of the Class A vehicles.

10. The method of claim 9, wherein the inquiring of one or more other parties comprises using one or more of internet websites, direct solicitation and combinations thereof.

11. The method of claim 7, which further comprises contacting the party or parties having been identified as being willing to purchase a Class C vehicle to advise the party or parties of the Class C status of the automobile the party or parties are willing to purchase.

12. The method of claim 11, which further comprises inquiring of the party or parties having been identified as being willing to purchase a Class C vehicle if there is interest in purchasing a Class A vehicle or a Class B vehicle or another vehicle.

13. The method of claim 11, wherein the contacting and inquiring is continued on a periodic basis until the Class C vehicle becomes a Class A vehicle or a Class B vehicle.

14. The method of claim 13, wherein the contacting and inquiring is continued for no longer than a set period of time.

15. The method of any of claim 1, wherein the using a micro-chip-based computing device step is structured to obtain sufficient information so that more than one vehicle can be identified as being of interest to at least one party or a plurality of parties from whom the information is obtained.

16. The method of claim 1, wherein the information obtained identifies features (options) of each automobile of interest from the most wanted feature to the least wanted feature.

17. (canceled)
